(19) United States
(12) Patent Application Publication
(10) Pub. No.: US 2007/0261403 A1
(43) Pub. Date: Nov. 15, 2007

(54) Pressure shuttle

(76) Inventor: Craig T. Eppler, Mentor, OH (US)

Correspondence Address: FORREST L. COLLINS LAW OFFICES, LLC, P. O. BOX 41040, BRECKSVILLE, OH, 44141-0040, US

(21) Appl. No.: 11/431,913

(22) Filed: May 10, 2006

(51) Int. Cl. F16D 31/02

(52) U.S. Cl. 60/468

(57) ABSTRACT

A method and devices are disclosed by releasing residual pressure form a hydraulic system and maintaining hydraulic vent to reservoir until system start-up. Quick-connect quick-disconnect hydraulic devices may be utilized herein.

### BACKGROUND OF THE INVENTION

1. Field of the Invention

The purpose of this invention is to aid in the functionality of quick coupling hydraulic systems.

2. Description of the Art Practices

A trend in the construction industry has been to utilize smaller, more versatile machinery on the job-site. For example, mini-excavators and skid-steer loaders are often used to perform a variety of tasks. In many cases, a skid-steer loader or mini-excavator is equipped with an attachment for performing a particular task. Such attachments are typically powered by an auxiliary hydraulic circuit on the skid-steer loader or mini-excavator.

Numerous attachments exist for performing a variety of tasks. For example, attachments exist for allowing a skid-steer loader to be used as a backhoe, an earth auger, an angle broom, a drop hammer, a snowplow, a brush saw, etc. These attachments typically are designed to be quickly connected and disconnected from the skid-steer loader or other machine by an operator on the job-site. The ability to quickly change attachments on the job-site makes these smaller machines more versatile than larger machines.

Quick-disconnect couplers are often used to allow quick and convenient connection and disconnection of hydraulic lines of an attachment to the auxiliary hydraulic circuit of the machinery. These types of couplers also are often used on construction equipment or agricultural tractors for connecting auxiliary circuits that power work tools or pull behind implements. The couplers can be mounted at the end of piping, hoses or in manifolds in positions that are easily accessible to the operator when connecting an attachment. Generally the couplings are in close proximity to each other.

In general, an operator manually connects the hydraulic lines of an attachment to the auxiliary hydraulic circuit of the machine. To form the connection, a plug-like coupler part and a socket like coupler part are customarily used to couple the supply/return lines. In many instances, the connection is made while internal hydraulic pressure exists in one or both of the lines to be connected. Such internal hydraulic pressure can be residual hydraulic pressure from operating the attachment, or may be due to thermal hydraulic pressure buildup in the hydraulic circuit. Regardless, hydraulic pressure in the circuit can make forming the connection more difficult, especially with standard quick-disconnect couplers.

The ability of a coupler to connect and disconnect, as intended to another coupler or fitting, can be highly dependent on the system within which it operates and specifically on the displacement volume of the coupling as it connects. Many couplers have internal valves that are biased closed by internal pressure and assisted by a spring when the coupler is not connected to another coupler or fitting. Once the coupler is connected to another coupler or fitting, the internal valve is opened allowing flow therethrough. For the user, it becomes increasingly difficult to make a connection as internal pressure, and thus hydraulic force, on the valves of the two couplers to be connected increases. In the hydraulic coupling industry, difficulty in making a connection due to hydraulic pressure is known as the “connect under pressure” problem.

Hydraulic pressure within a coupling is essentially a form of trapped energy. Thus, in order to connect a coupling under pressure, the trapped energy must be dissipated or otherwise managed. In general, this means that the energy within the coupling must be dissipated during the connection, or must be moved or contained in a place where its effects are minimized.

The majority of couplers capable of connecting under pressure do so by dissipating the internal hydraulic energy by allowing the hydraulic fluid (e.g. oil) to expand prior to connection. Some couplers have internal bleed valves that let the oil expand to a low-pressure line within the hydraulic system. Other couplers are designed with an internal bleed valve that lets the oil expand into and through the mating coupler. Still other couplers incorporate a mechanism for providing a mechanical advantage to generate enough force to overcome the hydraulic forces acting on the valves. And still other couplers have an external bleed valve that lets the hydraulic fluid expand external to the system, i.e., into the environment.

Many prior art coupler designs providing connect under pressure functionality have specialized internal valving that provides the connect under pressure functionality. Such couplers are more complex and cost more than a standard coupler (i.e., couplers without internal valving) due to the internal valving. Further, many prior art coupler designs utilize elastomeric seals that are required to throttle flow during connect under pressure. It is well known that throttling flow over elastomeric seals increases the potential for seal damage and often results in such. Many prior art coupler designs also involve the need for operator training as the operation of the couplers is not intuitive.

Hiser in United States Patent Application 20050247359 published Nov. 10, 2005 describes a decompression valve assembly is normally open thereby allowing thermal pressure build-up in an auxiliary circuit to be dissipated via a bleed path. During operation, the bleed path is sealed by a check valve, whereby high pressure flow can be fully directed to the work tool powered by the auxiliary circuit, for high system efficiency. In addition, a velocity fuse feature limits the rate of flow to the bleed path, thereby to allow for controlled release of pressure from the auxiliary circuit, as is desirable to protect against a rapidly falling load.

Albrecht in U.S. Pat. No. 6,776,439 issued Aug. 17, 2004 describes flange plates control the flow of fluid between fluid handling devices. In one embodiment, a sealing plate includes an O-ring and a structural support ring disposed within the O-ring. The support ring prevents the O-ring from being dislodged due to fluid pressure in the line. The support ring may have chamfers which aid in centering the O-ring. The support ring may also have a plurality of orifices allowing fluid flow between the interior of the support ring and the O-ring. In another embodiment, a blanking plate includes a domed portion, oriented in a direction towards the fluid being contained. The domed portion imparts strength to the blanking plate, allowing the plate to be made of a thinner piece of material. In another embodiment, an orifice plate includes a domed portion as described above, with an orifice located at the center of the dome. The invention also provides sealing plates which provide structural support for slip-in fluid modules, and which also have central bores which transition from one diameter to another, allowing fluid components having ports of differing diameters to be connected together.

U.S. Pat. No. 6,564,140 Ichikawa, et al., issued May 13, 2003 presents a correction factor setting unit sets correction factors for a front-rear traction distribution control unit, an anti-lock brake control unit, a traction control unit, and a braking power control unit according to the situation of a road and the shape thereof which are inputted from a road information recognizing unit. At this time, the correction factors are preset values according to the situation of the road and the shape thereof so that the actions of the control units will be balanced with each other. Consequently, the plurality of vehicle behavior control units mounted in a vehicle act efficiently according to the situation of the road, on which the vehicle is driven forwards, and the shape thereof while quickly responding to the situation of the road and the shape thereof.

U.S. Pat. No. 6,283,151 issued to Countryman, et al., on Sep. 4, 2001 describes a coupling includes a male half and a female half, where the female half has a fitting rigidly fixed to a stationary member such as an agricultural tractor. The male half can be coupled within the female half. When the male and female halves are coupled together, a valve assembly in the female half allows fluid flow through the coupling. When the male half is pulled out of the female half, the male half automatically disconnects from the female half. When the male half is removed, the valve assembly closes to prevent fluid flow through the coupling. The male half also automatically disconnects when the fluid pressure in the fluid system increases above a predetermined amount. In either case, a coupler body within the fitting moves against a centering spring to allow the male half to be removed from the female half. The selection of an appropriate centering spring determines the breakaway and overpressure release force. The male half can also be uncoupled from the female coupling half by manual manipulation of a locking collar.

U.S. Pat. No. 6,237,631 to Giesler, et al., issued May 29, 2001 A female coupling member for a low-spill, quick-disconnect coupling where a male coupling member has a valve with a conical head projecting axially forward of a forward end of a body of the male coupling member. The female coupling member includes a body having an axially-extending internal cavity with a forward end dimensioned to receive the body of the male coupling member. An annular piston sleeve is spring-biased forwardly within the internal cavity of the female body. A radially-inward projecting annular valve seat in the female body separates a rear cavity portion of the internal cavity from a forward cavity portion. A valve stem assembly is slideably received within the internal cavity of the female body. The valve stem assembly includes i) a poppet valve dimensioned to be sealingly seated forwardly against the valve seat in the female body when the female coupling member is in an uncoupled condition; and ii) a valve stem portion connected to the poppet valve and extending forward of the poppet valve. The valve stem portion includes an enlarged valve head sealingly mating with a valve seat on the piston sleeve when the female coupling member is in the uncoupled condition. The valve head includes a forwardly-opening conical cavity dimensioned to closely receive the conical valve head of the male coupling member. The male coupling member axially-displaces the piston sleeve and the valve stem assembly rearward in the female body away from their respective valve seats when the male coupling member is inserted into the female coupling member to provide a flow path through the female coupling member.

U.S. Pat. No. 5,649,377 issued Jul. 22, 1997 to Tanada recites a multipurpose bucket structure can carry long materials, pull down a building into pieces and take away the pieces, disassembly an automobile and take away the parts, work with a large-sized tool, dig the ground, for put an area destroyed by a disaster in order, carry ready-mixed concrete and carry concrete blocks or secondary products of concrete. In the bucket structure, an openable bucket is attached in an openable manner to a body bucket by an actuating cylinder, and the buckets are formed with tooth portions for grasping materials. The bucket structure thus constructed of the body bucket and openable bucket can be swiveled in a plane normal to the opening and closing direction of the openable bucket. The openable bucket is automatically locked in its closed position and in any open angle position. On the other hand, the swivel mechanism is equipped with a locking mechanism for locking it in a swivel position.

U.S. Pat. No. 5,141,014 Poli, et al., issued Aug. 25, 1992 sets out a breakaway coupling for joining two hoses includes a main body and an end body which are telescopically connected. A frangible link holds the two parts together. The link is inserted in a recess formed in a surface of the coupling which spans the junction of the bodies. The link is subject only to tensile forces and is formed to break at across the center of the link, where the two bodies abut each other. Each body includes a check valve. When the two bodies are connected, the valves urge against one another to open the valves. The urging of the valves against one another also exerts a tensile force on the link to hold it in its recess. A spacer separates the valves so that high pressure flow will not close the upstream valve.

Carow, et al., in U.S. Pat. No. 5,115,836 issued May 26, 1992 describes a breakaway hose coupling with an integrated swivel mechanism for releasably joining two fluid dispensing devices, and for selectively disengaging such dispensing devices in response to a disengaging force in excess of a preselected value being exerted on said coupling device. The coupling comprises a first valve assembly for being secured on a first dispensing device and for selectively terminating the flow of fluid from such dispensing device when the coupling is uncoupled. The coupling further comprises a second valve assembly with an integrated swivel mechanism for being secured on a second dispensing device and for selectively terminating the flow of fuel from the second dispensing device when the coupling is uncoupled. The coupling also includes automatic disconnect means for maintaining the first and second valve assemblies in an engaged position in the absence of disengaging force in excess of a preselected value being applied to the coupling, and for disengaging the first and second valve assemblies in response to disengaging force in excess of said preselected value being applied to the coupling, whereupon the first and second valve assemblies terminate the flow of fluid from their operatively associated dispensing devices.

U.S. Pat. No. 4,269,389 issued to Ekman on May 26, 1981 sets out a coupling device has two connectable and disconnectable units. A first unit is provided with a centrally arranged body and an inner casing slidingly arranged between two positions. In a first position, the inner casing cooperates with the central body to keep closed a passage for a fluid medium through the first unit. A second unit has a front section interactable with the inner casing in order to force the casing to a second position against the force of a spring which urges the casing towards the body. In the second position of the casing, the passage for the fluid medium is opened. The second unit also has a valve which closes a passage for the fluid medium when the units are in the disconnected position and opens said passage when the units are in the connected position. U.S. Pat. No. 4,219,048 also to Ekman issued Aug. 26, 1980 contains similar disclosures to U.S. Pat. No. 4,269,389.

To the extent that the foregoing references are relevant to the present invention, they are herein specifically incorporated by reference. To the extent that the foregoing patents and citations are relevant to the present invention they are herein incorporated by reference. The portion of the disclosure of this patent document contains material that is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### SUMMARY OF THE INVENTION

The present invention describes a hydraulic system comprising:
a hydraulic pump connected with a hydraulic fluid reservoir for when in use, supplying hydraulic fluid from said hydraulic fluid reservoir,
a directional spool valve assembly in fluid communication with said hydraulic pump to receive the hydraulic fluid;
a first hydraulic fluid reservoir line connected with said directional spool valve assembly, for when in use, to return hydraulic fluid to the hydraulic fluid reservoir;
a first hydraulic line connected with said spool valve assembly;
   a second hydraulic line connected with said spool valve assembly;
a third hydraulic line connected with said first hydraulic line;
a fourth hydraulic line connected with said second hydraulic line;
a valve body having a shuttle valve chamber;
said valve body connected at a first opening of said shuttle valve chamber with said third hydraulic line,
said valve body connected at second opening of said shuttle valve chamber with said fourth hydraulic line,
a shuttle valve contained within said shuttle valve chamber, for when in use, to alternately permit the flow of hydraulic fluid from said third hydraulic line and said fourth hydraulic line to said shuttle valve chamber;
   said valve body having an opening to a reservoir return chamber;
   said reservoir return chamber having located therein a velocity valve mechanism;
   said reservoir return chamber having a hydraulic fluid reservoir return line, for when in use, to return hydraulic fluid to the hydraulic fluid reservoir.

A further embodiment of the invention is a poppet comprising:

a first cylindrical region and a second cylindrical region;

said first cylindrical region and said second cylindrical region being coaxial;

said first cylindrical region having a larger diameter than the diameter of said second cylindrical region;

said second cylindrical region having a greater lengthwise dimension than said first cylindrical region; and,

said first cylindrical region having at least one lengthwise conduit extending therethrough outside of said second cylindrical region.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is an engineering drawing according to the invention;

FIG. 2 is a perspective of a valve body according to the invention;

FIG. 3 is a side view of the valve body according to FIG. 2;

FIG. 4 is a plan view of the valve body according to FIG. 2;

FIG. 5 is an end view of the valve body according to FIG. 2;

FIG. 6 is an partial assembled view of an aspect of the invention;

FIG. 7 is a view of FIG. 6 taken along line 7-7;

FIG. 8 is an end view according to FIG. 6;

FIG. 9 is a perspective of a retainer/shuttle seat according to the invention;

FIG. 10 is a first side view according to FIG. 9;

FIG. 11 is a first side view according to FIG. 9;

FIG. 12 is an end view according to FIG. 9;

FIG. 13 is a perspective of a poppet according to a further aspect of the invention;

FIG. 14 is a first side view of the poppet of FIG. 13;

FIG. 15 is a second side view of the poppet of FIG. 13; and,

FIG. 16 is an end view of the poppet of FIG. 13.

With more particular reference to the drawings the following is set forth.

### DETAILED DESCRIPTION OF THE INVENTION

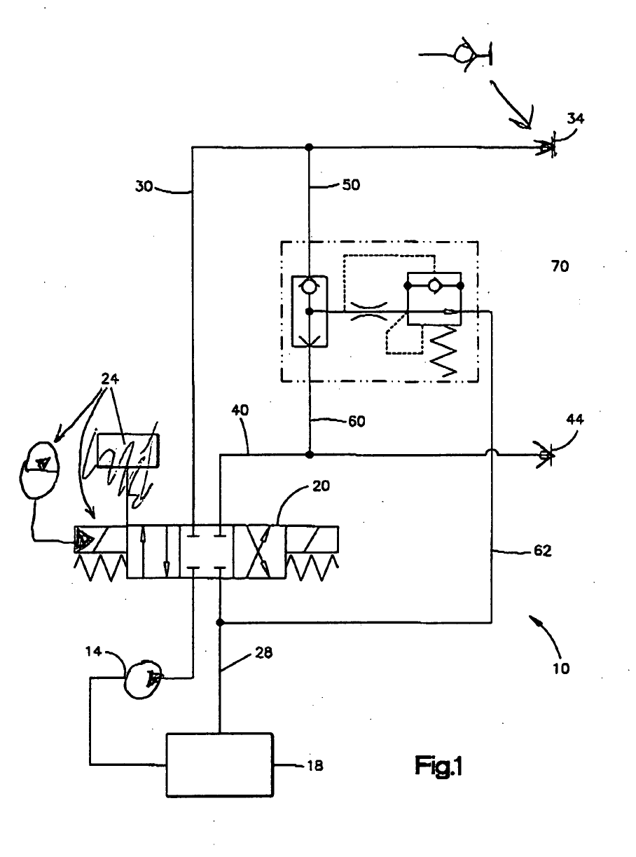

As shown in FIG. 1 is a hydraulic system 10. The hydraulic system comprises a hydraulic pump 14, a hydraulic fluid reservoir 18, a directional spool valve assembly 20, and spool valve accumulator 24.

Further according to FIG. 1, the hydraulic system 10 comprises a first hydraulic fluid reservoir line 28, a first hydraulic line 30, a first hydraulic quick-disconnect coupling 34, a second hydraulic line 40, a second hydraulic quick-disconnect coupling 44, a third hydraulic line 50, and a fourth hydraulic line 60.

The hydraulic pump 14 is in fluid communication with the hydraulic fluid reservoir 18. The hydraulic pump 14 supplies hydraulic fluid to the directional spool valve assembly 20. The directional spool valve assembly is operated by the spool valve controls 24. For simplicity's sake, other hydraulic components on the machine, but outside this auxiliary section of the hydraulic system are left out of this circuit diagram because they have no significant affect on the invention.

The first hydraulic fluid reservoir line 28 is in fluid communication with the hydraulic fluid the hydraulic fluid reservoir 18. The first hydraulic fluid reservoir line 28 is also in fluid communication with the directional spool valve assembly 20.

The directional spool valve assembly 20 is connected with the first hydraulic line 30. When desired the spool valve assembly 20 may supply pressurized hydraulic fluid to the first hydraulic line 30 from the hydraulic pump 14 or drain fluid from the first hydraulic line 30 to the first hydraulic fluid reservoir line 28.

The directional spool valve assembly 20 is also connected with the second hydraulic line 40. When desired the spool valve assembly 20 may supply pressurized hydraulic fluid to the second hydraulic line 40 from the hydraulic pump 14.

The first hydraulic line 30 terminates at one end with the first hydraulic quick-disconnect coupling 34. The first hydraulic quick-disconnect coupling 34 may be of any conventional type of fitting such as the popular quick-connect quick-disconnect variety.

The second hydraulic line 40 also terminates at one end with the hydraulic quick disconnect coupling. The second hydraulic quick disconnect coupling 44 may be of any conventional type of fitting such as the popular quick-connect quick-disconnect variety.

The first hydraulic line 30 has a branch hydraulic line 50. The second hydraulic line 40 has a branch hydraulic line 60. The branch hydraulic line 50 is connected with a valve body 70. The branch hydraulic line 60 is also connected with the valve body 70.

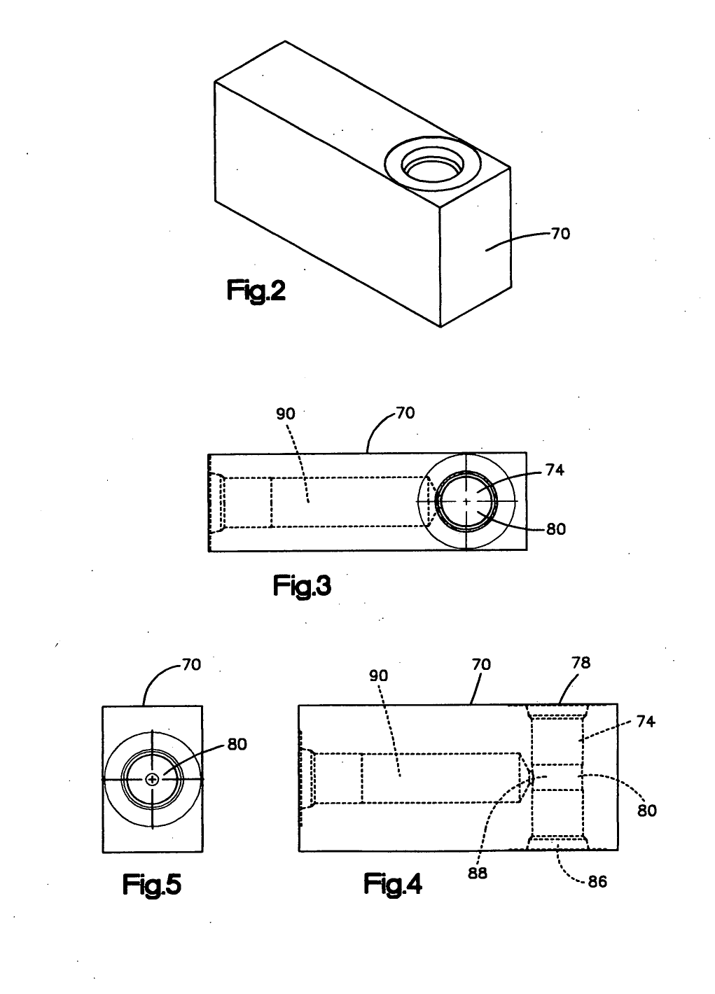

As best seen in FIGS. 2 through 5, is the valve body 70. The valve body 70 has a shuttle valve chamber 74. The shuttle valve chamber 74 has a valve body first opening 78 on one side thereof. A shuttle valve 80, as later described, is designed to fit within the shuttle valve chamber 74. The shuttle valve chamber 74 has a valve body second opening 86 opposite the valve body first opening 78. The shuttle valve chamber 74 extends through the valve body 70. The valve body first opening 78 and the valve body second opening 86 have threaded surfaces (not shown).

A valve body third opening 88 is located in the valve body 70 intermediate the valve body first opening 78 and the valve body second opening 86. The valve body third opening 88 is generally perpendicular to the shuttle valve chamber 74. The valve body third opening 88 flares outward toward a reservoir return chamber 90 in the valve body 70.

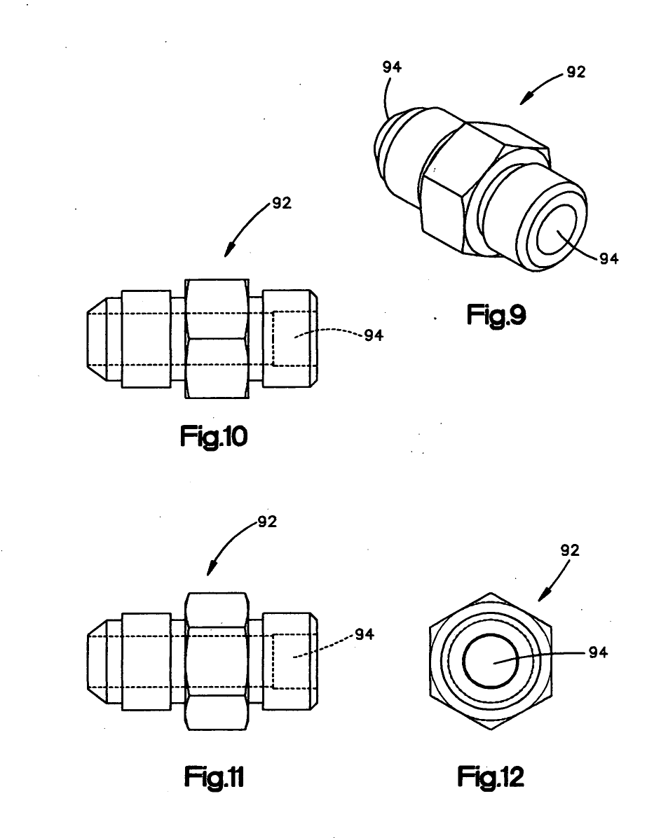

As best seen in FIGS. 9 through 12, is a valve body retainer/shuttle seat 92. A valve body nipple channel 94 extends through the length of the valve body nipple 92. The valve body retainer/shuttle seat 92 is fixed in place with the valve body first opening 78. The valve body retainer/shuttle seat channel 94 provides fluid communication with the shuttle valve chamber 74. The valve body retainer/shuttle seat 92 may be threaded on an outer surface thereof.

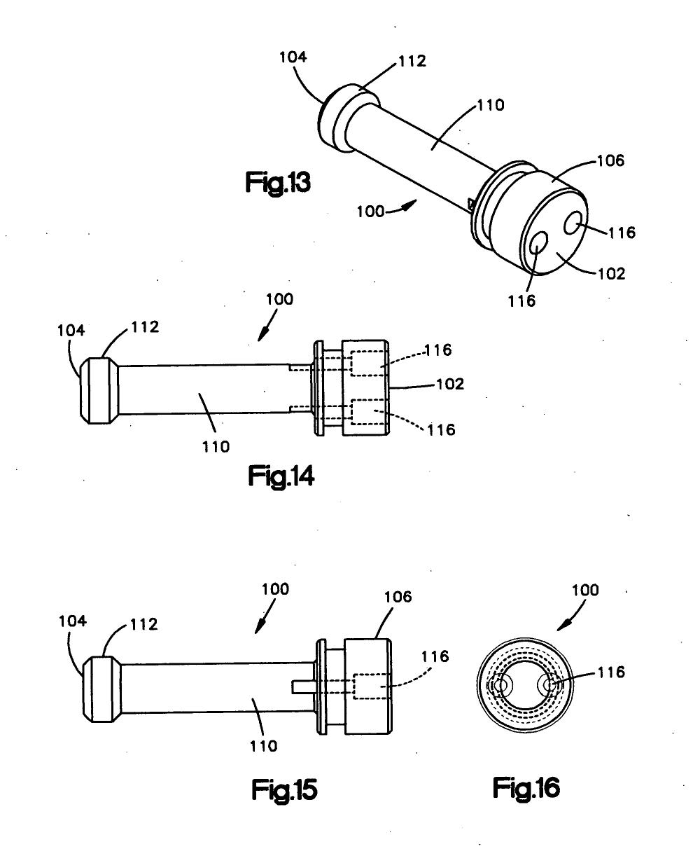

A poppet 100 is shown in FIGS. 13 through 16. The poppet 100 has a piston first end 102 and a poppet second end 104. The piston first end 102 is circular and flat. The poppet second end 104 is circular and tapered.

The poppet 100 is generally cylindrical having a first cylindrical region 106, a second cylindrical region 110, and a third cylindrical region The first cylindrical region 106, the second cylindrical region 110, and the third cylindrical region 112 are all coaxial along the length of the poppet 100.

The first cylindrical region 106 has a larger diameter than the third cylindrical region 112. The third cylindrical region 112 has a larger diameter than the second cylindrical region 110.

A pair of first cylindrical region lengthwise conduits 116 extend through the first cylindrical region 106. The pair of first cylindrical region lengthwise conduits 116 lie outside of the outermost diameter of the second cylindrical region 110.

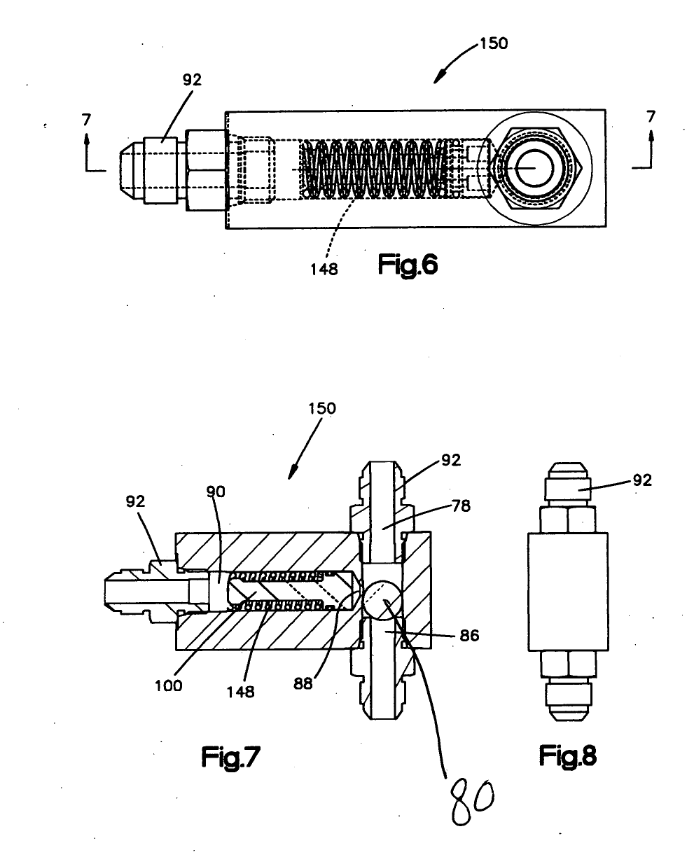

Turning to FIGS. 6 through 8, the valve body 70 is assembled. One valve body retainer/shuttle seat 92 is screwed into the valve body first opening 78. The shuttle valve 80 is inserted into the shuttle valve chamber 74. The shuttle valve 80 is generally spherical but may have a variety of shapes. The essence of the shuttle valve 80 is that it is moveable within the shuttle valve chamber 74 and capable of sealing, when so positioned, the valve body first opening 78, and the valve body second opening 86. When sealing valve body opening 78 a hydraulic flow path is open from valve body opening 86 to valve body third opening When sealing valve body opening 86 a hydraulic flow path is open from valve body opening 78 to valve body third opening 88.

A second valve body retainer/shuttle seat 92 is then screwed into the valve body second opening 86. The shuttle valve 80 is thereby secured in the shuttle valve chamber 74.

A poppet 100 is inserted into a velocity spring 148. The second cylindrical region 110 and the third cylindrical region 112 fit loosely within the helical structure of the velocity spring 148. The first cylindrical region 106 of the poppet 100 is larger than the outside diameter of the velocity spring 148.

The assembled poppet 100 and the velocity spring 148 are placed in the reservoir return chamber 90. The piston first end 102 of the first cylindrical region 106 is placed toward the valve body third opening 88. The assembled poppet 100 and the velocity spring 148 fit snugly in the reservoir return chamber 90. The remaining valve body nipple 92 is then screwed into the reservoir return chamber 90 thereby securing the poppet 100 and the velocity spring 148 in place. Together the poppet 100 and the velocity spring 148 form the velocity valve mechanism 150.

A hydraulic fluid reservoir drain line 62 is connected to the valve body nipple 92 proximate to the reservoir return chamber 90. The third hydraulic line 50 is connected to one valve body nipple 92 and the fourth hydraulic line 62 is connected to a second valve body nipple 92.

When the hydraulic pump 14 is in operation the directional valve assembly 20 is used to direct hydraulic fluid from the hydraulic fluid reservoir 18 to the first hydraulic line 30 or second hydraulic line 40 depending on the shifted position of the directional valve assembly 20. If a piece of equipment (not shown) is attached to the first hydraulic quick-disconnect coupling 34 and the second hydraulic quick-disconnect coupling 44 the equipment may be operated in one or two directions by manipulation of the 20 by the 24.

The hydraulic fluid will typically be supplied to the first hydraulic line 30 and second hydraulic line second hydraulic line 40 at up to 3000 PSI depending on the system requirements. A small amount of the hydraulic fluid from the pump will be directed from the first hydraulic line 30 to the 50 or from the second hydraulic line 40 to the fourth hydraulic line 60. The hydraulic fluid will enter the shuttle valve chamber 74 moving the shuttle valve 80 in the direction of fluid flow.

A portion of the hydraulic fluid will begin to enter the valve body third opening 88 from the shuttle valve chamber 74. The hydraulic fluid entering the valve body third opening 88 will encounter resistance to fluid flow at the pair of first cylindrical region lengthwise conduits 116, e.g. the cross sectional area of valve body third opening 88 is greater than the pair of first cylindrical region lengthwise conduits 116. Accordingly, a pressure differential will occur with the high pressure being on the piston first end 102 of the poppet 100 and the low pressure being on the poppet second end 104. The poppet 100 will then compress the velocity spring 148 and when the pressure differential reaches a pre-determined rate the poppet second end 104 will seat and prevent fluid flow to the hydraulic fluid reservoir drain line 62. The foregoing regime is needed to avoid unnecessary horsepower loss from the hydraulic system 10.

When the hydraulic system 10 is shut down and the equipment disconnected from the first pressure fitting 34 and the second pressure fitting 44 the poppet second end 104 remains seated blocking any flow of hydraulic fluid to the hydraulic fluid reservoir drain line 62. The hydraulic system 10 may have the hydraulic fluid in the first hydraulic line 30 and the second hydraulic line 40 bled off by various means such as an accumulator to allow flow from the spool valve assembly 20 via the first hydraulic fluid reservoir line 28 to the hydraulic fluid reservoir 18.

In the present invention the drop in pressure to the pre-determined rate typically around 200-300 psi in the first hydraulic line 30 and second hydraulic line 40 results in the velocity spring 148 repositioning the poppet 100 in the reservoir return chamber 90. As such the poppet second end 104 moves away from its seated position in the reservoir return chamber 90. The velocity spring 148 may be tensioned at several response pressures. In the present invention movement of the 100 begins at, for example, 240 PSI. Consequently, the hydraulic fluid in the reservoir return chamber 90 begins to drain into the hydraulic fluid reservoir drain line 62. Simultaneously, hydraulic fluid from the shuttle valve chamber 74 begins to pass through the first cylindrical region lengthwise conduits 116 to flow to the hydraulic fluid reservoir drain line 62 decompressing all hydraulic fluid in the auxiliary hydraulic system to zero or near-zero psi pressure. The flow path 88 will remain open venting the auxiliary hydraulic system until the next system start-up. The lack of compression of the hydraulic fluid will then permit manual pressure to connect and equip hydraulic line to the first hydraulic quick-disconnect coupling 34 or the second hydraulic quick disconnect coupling 44.

The shuttle valve 80 will be urged toward the lower pressure of the first hydraulic line 30 or the second hydraulic line 40. When the 80 is positioned past the valve body third opening 88 the hydraulic in the higher-pressure line will flow into the reservoir return chamber 90. In this manner the pressure between the first hydraulic line 30 and the second hydraulic line 40 will be equalized and lowered sufficiently to permit a quick-connect to the first pressure fitting 34 and the second pressure fitting 44.

From the above description of the invention, those skilled in the art will perceive improvements, changes and modifications. Such improvements, changes and modifications within the skill of the art are intended to be covered by the appended claims.

What is claimed is:

1. A hydraulic system comprising:
a hydraulic pump connected with a hydraulic fluid reservoir for when in use, supplying hydraulic fluid from said hydraulic fluid reservoir;
a directional spool valve assembly in fluid communication with said hydraulic pump to receive the hydraulic fluid;
a first hydraulic fluid reservoir line connected with said directional spool valve assembly, for when in use, to return hydraulic fluid to the hydraulic fluid reservoir;
a first hydraulic line connected with said spool valve assembly;
a second hydraulic line connected with said spool valve assembly;
a third hydraulic line connected with said first hydraulic line;
a fourth hydraulic line connected with said second hydraulic line;
a valve body having a shuttle valve chamber;
said valve body connected at a first opening of said shuttle valve chamber with said third hydraulic line,
said valve body connected at second opening of said shuttle valve chamber with said fourth hydraulic line,
a shuttle valve contained within said shuttle valve chamber, for when in use, to alternately permit the flow of hydraulic fluid from said third hydraulic line and said fourth hydraulic line to said shuttle valve chamber;
said valve body having an opening to a reservoir return chamber,
said reservoir return chamber having located therein a velocity valve mechanism;
said reservoir return chamber having a hydraulic fluid reservoir return line, for when in use, to return hydraulic fluid to the hydraulic fluid reservoir.

2. A device for reducing hydraulic pressure comprising:
a valve body having a shuttle valve chamber,
said valve body having a first opening of said shuttle valve chamber to permit connection with a hydraulic line,
said valve body having a second opening of said shuttle valve chamber to permit connection with a hydraulic line,
a shuttle valve contained within said shuttle valve chamber, for when in use, to alternately permit the flow of hydraulic fluid from said third hydraulic line and said fourth hydraulic line to said shuttle valve chamber;
said valve body having an opening to a reservoir return chamber,
said reservoir return chamber having located therein a velocity valve mechanism;
said reservoir return chamber having a hydraulic fluid reservoir return opening to permit connection with a hydraulic fluid reservoir return line.

3. A poppet comprising:
a first cylindrical region and a second cylindrical region;
said first cylindrical region and said second cylindrical region being coaxial;
said first cylindrical region having a larger diameter than the diameter of said second cylindrical region;
said second cylindrical region having a greater lengthwise dimension than said first cylindrical region; and,
said first cylindrical region having at least one lengthwise conduit extending therethrough outside of said second cylindrical region.

4. The poppet according to claim 3 wherein at least two lengthwise conduits extend therethrough outside of said second cylindrical region.

5. A method of reducing the pressure within a hydraulic system comprising:
a first hydraulic line having hydraulic fluid therein connected with said spool valve assembly;
a second hydraulic line having hydraulic fluid therein connected with said spool valve assembly;
a third hydraulic line having hydraulic fluid therein connected with said first hydraulic line;
a fourth hydraulic line having hydraulic fluid therein connected with said second hydraulic line;
said first hydraulic line terminating at one end thereof with a first pressure fitting;
said second hydraulic line terminating at one end thereof with a second pressure fitting;
a valve body having a shuttle valve chamber;
said third hydraulic line connected with said valve body having a shuttle valve chamber at a first opening;
said fourth hydraulic line connected at second opening with said valve body at a second opening;
said shuttle valve chamber having a shuttle valve contained within said shuttle valve chamber;
said valve body having an opening to a reservoir return chamber having hydraulic fluid therein;
said reservoir return chamber having located therein a velocity valve mechanism;
said reservoir return chamber having a hydraulic fluid reservoir return line;
provided that the hydraulic pressure in said first hydraulic line and said second hydraulic line is substantially at the ambient external pressure and that an equipment operator of the hydraulic system is connecting an equipment hydraulic line to said first hydraulic line at said first pressure fitting;
wherein when the hydraulic pressure of said third hydraulic line decreases to a predetermined amount the hydraulic fluid within said reservoir return chamber urges said velocity valve toward said opening thereby permitting the flow of hydraulic fluid into said hydraulic fluid reservoir return line;
provided further that the hydraulic pressure of said fourth hydraulic line will urge said shuttle valve toward said first opening thereby permitting the hydraulic fluid in said fourth hydraulic line to flow through said opening into the reservoir return chamber and into said hydraulic fluid reservoir return line.
